(19) United States
(12) Patent Application Publication
(10) Pub. No.: US 2001/0046208 A1
(43) Pub. Date: Nov. 29, 2001

(54) Unbreakable optical IP flows and premium IP services

(76) Inventors: Kai Y. Eng, Atlantic Highlands, NJ (US); Jon Anderson, Brielle, NJ (US); Pramod Pancha, Somerset, NJ (US)

Correspondence Address: KAPLAN & GILMAN , L.L.P., 900NROUTE 9 NORTH, WOODBRIDGE, NJ, 07095, US

(21) Appl. No.: 09/840,299

(22) Filed: Apr. 23, 2001

Related U.S. Application Data
(63) Continuation-in-part of application No. 09/565,727, filed on May 5, 2000.
(63) Continuation-in-part of application No. 09/734,364, filed on Mar. 5, 2001.
(60) Provisional application No. 60/234,122, filed on Sep. 21, 2000.
(60) Provisional application No. 60/250,246, filed on Nov. 30, 2000.

(51) Int. Cl. H04L 12/26; H04L 12/54

(52) U.S. Cl. 370/229; 370/429

(57) ABSTRACT

A data network routing apparatus and method are presented. The routing apparatus comprises a packet engine, which itself comprises a switch, a forwarding engine and a queueing processor. The queueing processor tracks individual input port to output port flows, and assigns packets to these flows. Flows are assigned to queues. Each queue can accommodate a large number of packets. Each queue is assigned to a subclass, and a number of subclasses are assigned to a class. The apparatus and method thus support numerous differentiable classes of data as well as further differentiable subclasses within each class. While queues within a given subclass are served with equal priority by the routing apparatus, each subclass can be assigned a different weight to differentiate the priority within a subclass. In turn, each class can be assigned a different weighting as well, to allow different treatment before reaching an output port. Thus, a wide spectrum of service differentiation is supported. When implemented in a high-speed integrated optical-electronic data network with near immediate restoration and rerouting capabilities, premium IP services can be offered with quality and service guaranteed even under the most extreme high-traffic and failure scenarios.

### RELATED APPLICATIONS

This application claims the benefit of U.S. Provisional Application No. 60/234,122, filed on Sep. 21, 2000, and also claims the benefit of U.S. Provisional Application No. 60/250,246, filed on Nov. 30, 2000, each naming Kai Y. Eng as Inventor. Additionally, this application is a continuation-in-part of pending U.S. application Ser. Nos. 09/565,727, filed on May 5, 2000, and 09/734,364, filed on Dec. 11, 2000, the disclosure of each of which is incorporated herein in its entirety by this reference.

### TECHNICAL FIELD

This invention relates to large-scale service level based packet control in data networks, and, in particular, to a technique of hierarchical organization of large numbers of data flows in a data network into multiple classes and subclasses, each serviced with a different priority. Such technique allows the provision of a wide variety of premium service classes.

### BACKGROUND OF THE INVENTION

Optical fiber networks, such as SONET, are in widespread use due to their ability to support high bandwidth connections. The bandwidth of optical fibers runs into gigabits and even terabits. Optical links can thus carry hundreds of thousands of communications channels multiplexed together. Optical fiber networks are subject to outages if and when breaks in the fibers occur. A cut in a single fiber between two network nodes could conceivably render communications along certain nodes of the system impossible. Moreover, because each fiber carries so many independent voice and/or data channels, a large number of communications sessions would be interrupted.

In a conventional packet switched data network, packets are multiplexed onto high speed connections between packet data switches. These switches are, at the data level, routers, such as the CISCO family of routers well known in the art. The routers output the data packets to a physical transport level constructed out of optical fibers and equipment to propagate the optical signals along them. Such optical transport equipment is commonly known, as, for example, that manufactured and sold by Lucent Technologies and Nortel Networks. In such networks, each router feeds into the transport network. Although the data layer and the physical layer exchange the data packets through each other, these layers are not integrated, and are each operated as discrete and autonomous entities. Each packet switch reads the address header in packets to be routed through the network, and interprets the required information for transmission from one switch to the next.

The connections between the packet switches are often extremely high speed, and carry a relatively large number of multiplexed packets. If a fiber is cut or a communications channel damaged in some other way, then a large volume of data would be cut off. Since the router, or data, layer of the network does not recognize a “fiber cut”, and only deduces its existence from the failure of a number of packets to acknowledge having arrived at the intermediate node, this information is not available to the router for some minutes. Accordingly, it is required, in order to insure reliability, that such networks have some way of recovering from cut fibers and/or other loss of data channel capability.

Besides the general need for reliability, certain types of data are considered as having a higher priority than others. Some data is very time sensitive, such as confirmation of electronic monetary transfers received at a distant foreign bank which are a precondition of a transaction closing in the home country, or securities purchase or sale orders in a gyrating market. Especially critical is the execution of simultaneous transactions in two or more markets for the purposes of arbitrage, hedging, or the like. Other data is less time sensitive, but absolutely sensitive to all the data reaching its destination. Among the many examples of this type of data are transactions effectuated over data networks. In these transactions the financial institution sees it as critical that its customers feel a sense of security in utilizing its online access tools. The financial institution insists that the electronic presence it projects be seen as flawless, secure, and absolutely responsive. A customer, whether a consumer or business, being told that “the computer is down, we lost your transaction, we will have to investigate and get back to you” is absolutely unacceptable. As well, in applications such as telemedicine, national security or defense, or teleoperational control of robotic devices in hazardous environments, where life affecting and/or extremely serious decisions are made on the basis of information received not from a local investigation or diagnosis, but rather from a remote location over a data network, it is absolutely critical that all the data that is sent is in fact received.

From the preceding it is clear that there is a wide gamut of data for which the persons and entities using data networks to send it desire guarantees of the arrival of such data, both in terms of no losses, as well as in terns of a maximum acceptable latency for the arrival of such data. Sometimes such data is a small fraction of the data sent from or received by a source or destination, as the case may be, and sometimes all of the data communicated to and from a given network node is such high priority data.

It is also clear to those knowledgeable and skilled in the art, that there are no data networks without some data losses. This is a result of the fact that no matter how well protected a network is, no matter how redundant, and no matter how well its data restoration capabilities, in the event of one or more fiber cuts, node failures, or multiple such failures, some data is lost in the intervening fractions of seconds before rerouting and restoration of data flow can occur. In the event that there are multiple failures, such fractions of seconds can increase by orders of magnitude. This data, to the extent not stored anywhere, is lost. At the data throughput rates of state of the art networks, even small fractions of such down time can result in the loss of large quantities of data.

In U.S. patent applications Ser. Nos. 09/565,727 and 09/734,634, commonly assigned with the present one, methods and apparatus have been described for advanced data recovery and immediate rerouting in high throughput data networks. These methods increase the reliability of timely data arrival, and reduce data loss and latency. These methods are made possible by the integration of the electrical and optical layers of the data network into a single layer, which combines the intelligence required for high speed large throughput switching with the scalable capacity of multi-wavelength optics. However, in all real world data networks, even state of the art integrated optical networks using the advanced methods described in such applications, it is impossible cannot guarantee the timely arrival of each and every packet.

Such realities naturally create the need for the provision of various grades of service which a network access provider or network service provider can offer to the users of the network. Tradeoffs of cost versus service guarantees will tend to price the higher grades of service at a higher cost. Data network service providers are thus eager for the tools to fully exploit this market, as such tolls would finally allows them to offer high margin differentiated IP services to a market waiting to be developed.

The notion of differentiated services has been discussed and standards set forth in RFC2474, RFC2475, RFC2597, and RFC2598, each of which can be accessed, for example, at http://www.ietf.org/rfc/rfcXXXX.txt, where XXXX stands for the RFC number desired. In the prior art, methods have been proposed and described to implement differentiated service, or quality of service distinctions across a network. They are generally restricted in some way, however. There are limits upon the possible number of queues, and thus upon the various levels of service a network provider can offer its customers, as well as internally use to prioritize data within an offered premium service category. Further the methods are often restricted to a particular type of data to be prioritized, such as isochronous data used in voice and audio communications. The reason for these restrictions is a simple one. It is a function of the limited queuing and queuing management capabilities offered by existing data networks.

Existing data networks tend to utilize a small number of bits, such as the IPv4 TOS field, to distinguish various classes of service. This limits the flavors of differentiated services that can be offered. As a result, bandwidth is allocated to each predefined fixed level of service, and if underutilized in the levels at the pinnacle of the priority hierarchy, “filled up” with data from the lower priority levels. There is no mechanism to dynamically adjust, increase, or decrease the various levels of differentiated service that the system offers, nor is there any means to dynamically adjust the relative priorities with which the different priority levels are serviced. Finally, even within the limited scope of differentiated service that is offered by current systems, in the event of a failure, significant quantities of data from even the highest priorities will be lost, inasmuch as there is no mechanism to buffer entire priority classes long enough to detect a fiber cut or other significant failure.

In view of the above, there exists a need in the art for a method of absolutely insulating various classes of data from communication link failures in the physical layer of data networks. Such a method would allow the identification of numerous grades of service, each grade offering various guarantees as to maximum data loss, as well as a maximum latency for any data packet associated with that grade of service. In the higher grades, the maximum data loss will be very small or zero, thus tantamount to a guarantee by a service provider of the absolute delivery of all or nearly all sent data even under the most extreme high-traffic and failure scenarios. Such guarantees would include a specific maximum temporal latency in the network, both in per packet absolute terms, as well as between any two successive packets, and would apply to the given amount of bandwidth contracted for. Such grades of service with the arrival, delay and jitter guarantees would be known as “premium services”, equivalent from the point of view of data networks, to the concepts of first class and business class in the realm of air travel.

However, providing premium service on modern high speed data networks requires more than just a mechanism to queue and manage different classes of data separately. The computing overhead required for managing, routing, and in the event of a fault or fiber cut, restoring and rerouting, the different classes of data must be accomplished without diminishing the throughput now required of modern data networks. As well, these functions would need to be occur at a rate sufficiently fast so as to have no significant data loss at the higher priorities. Therefore, such a method, by necessity, would need to exploit the temporal efficiencies and near immediate fault recovery capabilities of integrated optical-electrical networks, as disclosed in the related applications discussed above.

### SUMMARY OF THE INVENTION

The above and other problems of the prior art are overcome and a technical advance achieved in accordance with the teachings of the present invention.

A data network queuing and routing apparatus and method are presented. The apparatus comprises a packet engine, which itself comprises a switch, a forwarding engine and a queuing processor. The queuing processor tracks individual input port to output port flows, and assigns packets to these flows. Flows are assigned to queues. Each queue can accommodate a large number of packets. Each queue is assigned to a subclass, and a number of subclasses are assigned to a class. The apparatus and method thus support numerous differentiable classes of data as well as further differentiable subclasses within each class. While queues within a given subclass are served with equal priority by the routing apparatus, each subclass can be assigned a different weight to differentiate the priority within a subclass. In turn, each class can be assigned a different weighting as well, to allow different treatment before reaching an output port. Thus, a wide spectrum of service differentiation is supported. When implemented in a high-speed integrated optical-electronic data network with near immediate restoration and rerouting capabilities, premium IP services can be offered with quality and service guaranteed even under the most extreme high-traffic and failure scenarios.

The foregoing and other advantages and features of the present invention will become clearer upon review of the following drawings and detailed description of the preferred embodiments.

### BRIEF DESCRIPTION OF THE DRAWINGS

FIG. 1 depicts a block diagram of the system of the preferred embodiment of the invention;

FIG. 2 depicts a logical view of the system depicted in FIG. 1;

FIGS. 3A-3C illustrate the framing and headers utilized in a preferred embodiment of the invention;

FIG. 4 depicts an exemplary service differentiation implementation of the preferred embodiment of the invention;

### DETAILED DESCRIPTION OF THE PREFERRED EMBODIMENT

Because the provision of premium services, or differentiated grades of service, is accomplished via the routing, fault or failure recovery, and restoration capabilities of a network, the apparatus and method of the invention will be described in the context of a switching device, or network node device, for use in the modem high-speed data network.

The ability to make guarantees about data arrival, as well as guarantees regarding maximum delay through the network, is heavily dependent upon routing being accomplished at high speeds as well as upon restoration and re-routing in the event of a failure being accomplished in fractions of second. Thus, for illustrative purposes, the method and apparatus of the invention are showcased herein in an integrated electrical optical data network, where the electronic switching functionalities and the optical transport functionalities of the network are wholly integrated at each network node.

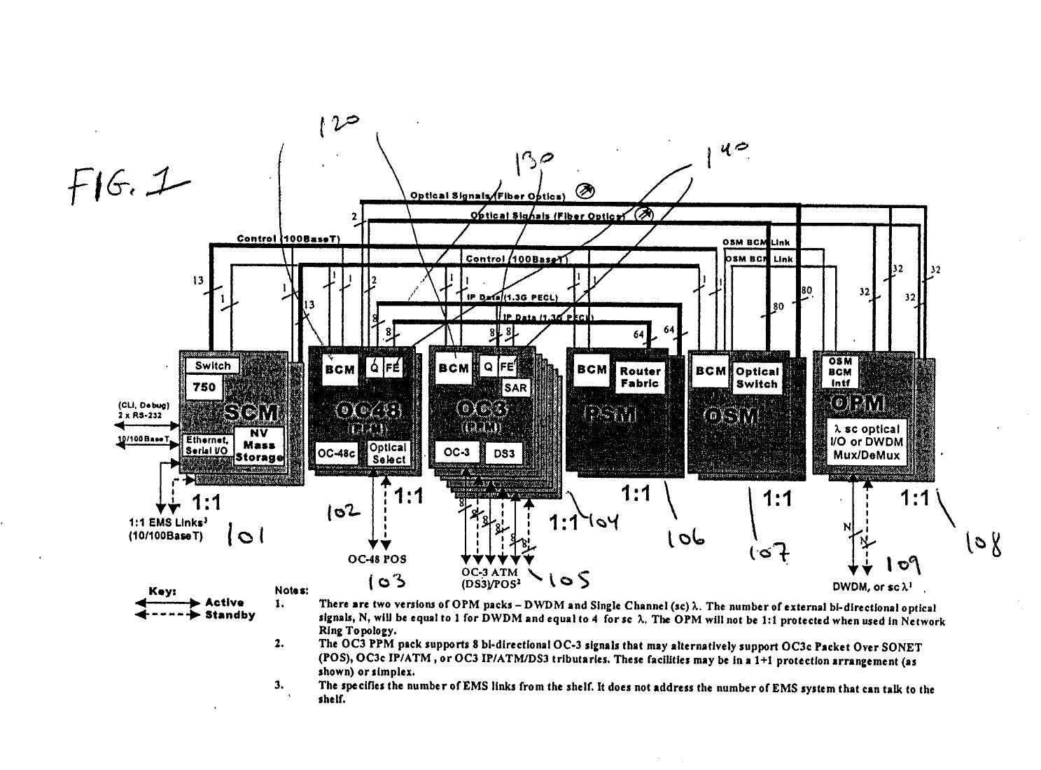

With reference to FIG. 1, just such an exemplary integrated electronic/optical network node is shown. There are two types of packet processing modules in the depicted embodiment, one that operates at OC-48 102 and another that operates at OC-3 104. A multitude of other operational speeds are understood to be equivalently implementable, according to the market demand, pricing structures and conditions then prevailing in any given present or future market. In this example, there are two OC-48 packet processing modules 102 and six OC-3 packet processing modules 104. Module 101, the system control module, or SCM, provides common control for all the modules, both electronic as well as optical, shown in this exemplary device configuration. The OC-48 packet processing module 102 interfaces the communication lines 103 to the access side of the network. In a parallel fashion, the set of OC-3 packet processing modules 104 interfaces with the access side of the network via the communication lines 105. In the particular embodiment of the network node depicted in FIG. 1, each of the sets of communications lines are one to one protected with complete backup communication lines for each active communication line.

Also depicted is the PSM or packet switch module, 106, the OSM, or optical switch module, 107 and the OPM, or optical processing module, 108. Within each of the packet processing modules 102 and 104, respectively, there are various subsystems. Each packet processing module has a board control module, or BCM, 120 which interfaces with the System Control Module 101. As well, each of the packet processing modules 102 and 104, respectively, have a queueing processor 130 and a forwarding engine 140. Together with the packet switch module 106, the queueing processors 130 and the forwarding engines 140 of the packet processing modules 102 and 104, make up the “Packet Engine” for the device. In this exemplary device the packet switch module 106 is an MPLS enabled IP routing switch. Thus, the PSM 106, in concert with the PPMs 102 and 104, not only performs standard IP routing as an IP router, but also can perform MPLS label switching, and MPLS traffic engineering.

The packet switch module 106 receives the IP flow data from the Forwarding Engine 140 of each packet processing module, 102 or 104. In this embodiment, such data consists of 72 byte packet chunks that are made up of 64 bytes of frame data and eight bytes of internal switch data. The internal switch data is appended to the frames by the system and consists of four bytes of switch fabric header and four bytes of queuing processor header. The packet switch module strips off the four bytes of switch fabric header and switches the remaining 68 byte package chunk to the output PPM specified in the switch fabric header. The packet switch module 106 then sends this data to the queuing processor of either of PPMs 102 or 104. The packet processing modules 102 and 104 are linked via high speed fiber optic links to the OSM 107 and the OPM 108. The optical processing module 108 is connected to the long haul, or transport portion of the network via fiber optic communications line 109.

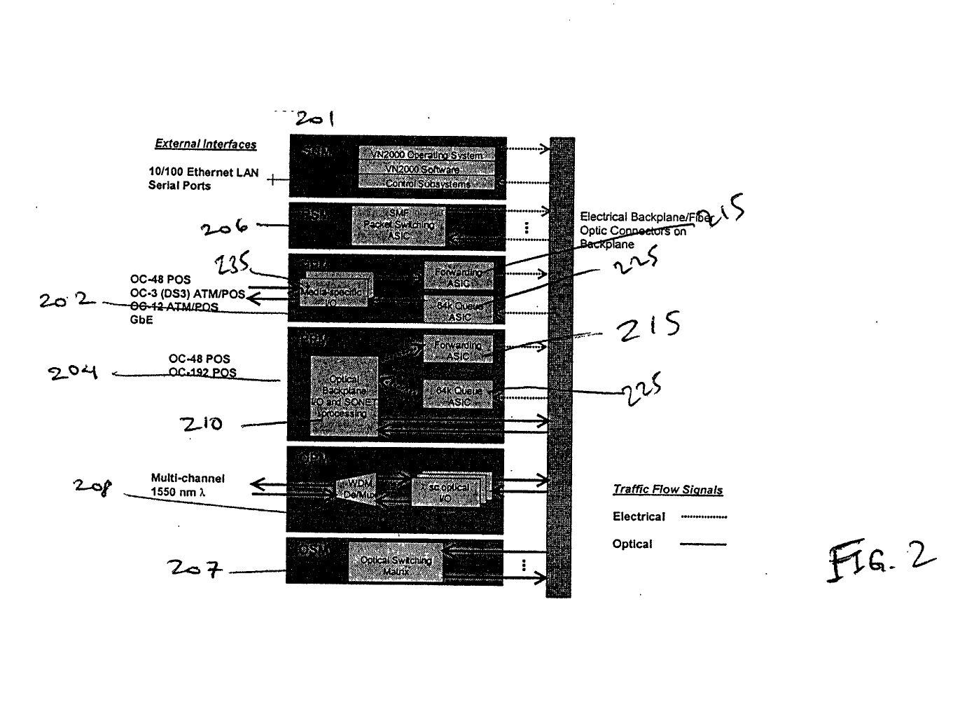

FIG. 2 depicts a logical view of the same example system as shown in FIG. 1. In it can be seen the system control module 201 where the operating system, software, and control subsystems for the device are stored. One can see as well the Packet Switch Module 206, the Packet Processing Modules 202 and 204, the Optical Switch Module 207 and the Optical Processing Module 208.

There are two types of signals that can enter the network node depicted in FIGS. 1 and 2. They are (a) signals originating remotely and entering the network node through the transport side of the network, and (b) signals generated locally entering the access side of the network node. What will first be described are the remote signals arriving at the network node with reference to FIG. 2.

Signals entering from remote locations come through the optical transport side of the network and enter the network node through the Optical Processing Module 208. They are then switched in the Optical Switching Module 207 and from there are sent to the Packet Processing Module 204 where they are interfaced through the Optical Backplane Input/Output Module 210 where the signal is converted to the electrical domain. The signal then passes to the Forwarding Engine 215 of PPM 204 through the electrical backplane to Packet Switch Module 206 to be switched to an output port. This signal then runs back through the electrical backplane to a given PPM, say for example 202, for output to the access side of the network. Upon entering PPM 202 the data goes through the Queueing Processor (“QP”) 225, and from there to the input/output port 235 of PPM 202 to the access side of the network, completing its journey through the network node device. A similar pathway would be taken for a remote to remote signal, except that, if IP routing is involved, after passing through the PSM 206 for IP routing, it would travel through the QP 225, through the Optical Backplane I/O 210, therein be converted to the optical domain, go through the OSM 207, again through the optical backplane, and output via the OPM 208 to a remote location. If no IP routing is involved the signal never leaves the optical domain, and simply enters via the OPM 208, travels through the optical backplane to the OSM 207, again through the optical backplane to the OPM 208 and out to a remote location. The input wavelength and output wavelengths can be, and in general often will be, different.

Signals entering the network node from the access side of the network are next described. Signals entering the network node from the access side of the network are themselves divisible into two categories. The first category would contain those signals, which are entering from the access side and are exiting from the access side of the network where the network node is simply performing IP routing. The other type of signals entering from the access side are those that are going to be IP routed by the network node, but as well sent to a remote location through the transport equipment. Each of these will be described in what follows.

The first type, the local to local signal, with reference to FIG. 2, enters a particular PPM, say for example, 202, through the Media Specific I/O port 235, to the Forwarding Engine 215, through the electrical backplane to the PSM 206, again through the electrical backplane back to the given PPM, and in particular, to the QP 225 of the given PPM. From there out of the PPM through the Media Specific I/O port 235 to the access side of the network.

In the case that the signal entering the network node is local but is going to be sent to a remote location, the signal pathway is as follows. Entering at PPM 202, the signal again passes through the Forwarding Engine 215, through the electrical backplane to the PSM 206, out through the electrical backplane to PPM 204, where it enters the QP 225. From there the signal travels to the optical backplane I/O Port 210 of PPM 204, and is converted to the optical domain. From there it travels to the optical backplane and is carried to the OSM 207 where it is assigned to an output port, and travels through the optical backplane to the OPM 208 and out through the long haul side of the network to its ultimate destination.

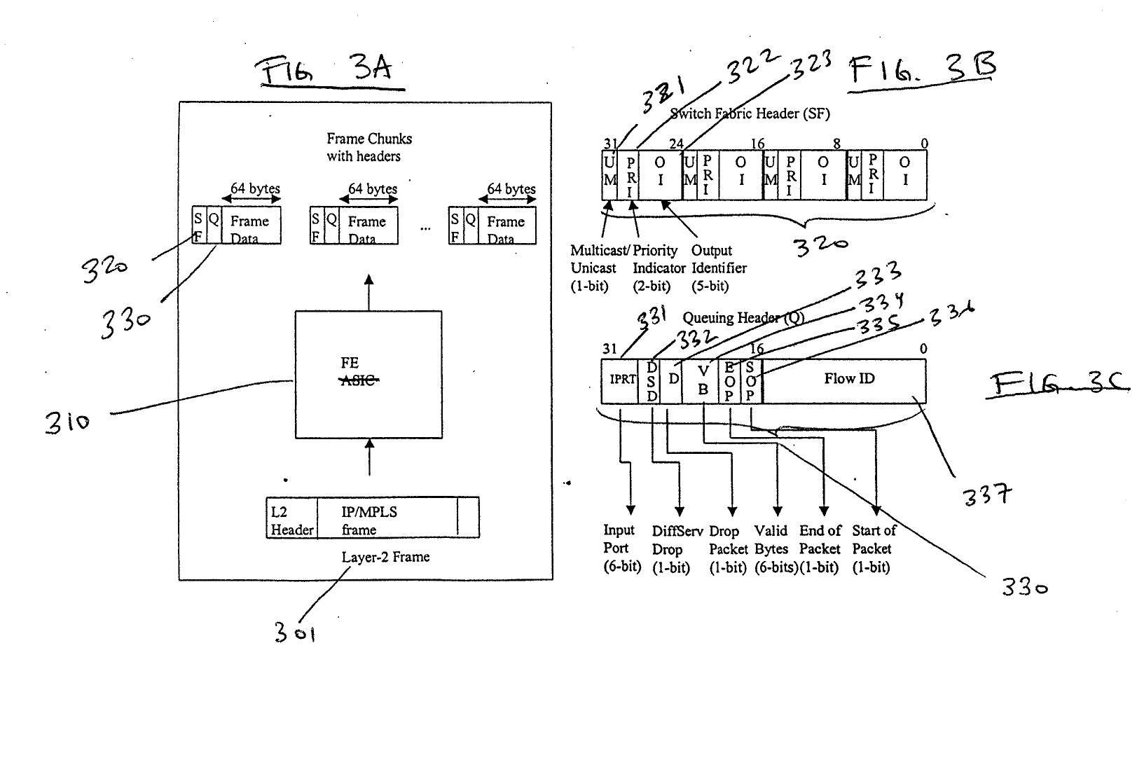

What will next be described with reference to FIGS. 3A-3C, are the internal labels that the PPMs, via the FEs 310, put on incoming data so as to achieve the differentiated services functionalities. With reference to FIG. 3A, what is shown is an exemplary implementation of internal labels appended to the beginning of an OSI Layer 2 frame 301. The frame is processed by the FE 310 which appends to each 64 byte frame that passes through it an additional internal header. Each header comprises two sections. The first section is the switching fabric header SF 320 which consists of 4 bytes in this exemplary implementation. The second part of the internal header is a queuing header Q 330 which also consists of 4 bytes in this exemplary embodiment. As can be seen in FIG. 3A, all the frames exiting the FE are now 72 bytes long; 64 bytes of the original frame and the added 8 bytes of headers prepended by the FE.

Turning now to FIG. 3B, the 4 bytes of the switching fabric header from FIG. 3A are now expanded to show the individual components. The Switch Fabric Header 320 consists of four identical bytes, of 8 bits each. The first bit is a multicast/unicast bit 321, the next 2 bits serve as a priority indicator 322, and the final 5 bits of each byte is the Output Identifier 323. As described above, the packet switch module, 206 with reference to FIG. 2, strips off the four bytes of SF 320, and switches the remaining 68 byte package chunk to the output PPM, 202 or 210 in FIG. 2, specified in the SF 320. As is further described above, the packet switch module 206 then sends this 72-byte package chunk to a queuing processor of the given packet processing module, for example, 202 or 204 with reference to FIG. 2. The contents of the queuing header will next be described with reference to FIG. 3C.

In a preferred embodiment, the queuing header Q 330 is divided into seven sections. They consist of the 6-bit Port Identifier 331, the Diffserv Drop bit 332, the Drop Packet bit 333, the 6-bit Valid Bytes Identifier 334, the End of Packet bit 335, the Start of Packet bit 336 and the Flow ID 337. As can be seen, the Flow ID here consists of the LSB bits 0-15 of Q 330, for a total of 16 bits of information. Thus, in this embodiment, the queuing processor of each PPM can uniquely identify 2¹⁶, or 65,536 distinct queues. The assignment of a packet chunk to a flow queue is performed by parsing the 32-bit queue header 330 prepended to each packet chunk. Each per flow queue has a threshold that can be set through the local bus of the BCM module (120 with respect to FIG. 1). In this embodiment, when assigning a frame to a flow queue, if a queue link threshold flow would be exceeded, the frame maybe dropped if the DS drop bit, 332 in FIG. 3C, is set for the current frame. The frame is also dropped if the global threshold for the system buffers is reached. It is understood that alternative embodiments can specify more complex rules governing when a packet can be dropped, and assign various header bits to encode the various possibilities within the congestion management scheme.

Flow queues are assigned to N scheduling classes and M scheduling subclasses based upon the Flow IDs 337 in FIG. 3C. Each class and subclass can be assigned a fraction of the total bandwidth for a port. Each port can be assigned a fractional amount of the total bandwidth of the PPM. The weights for each of the classes, and of the subclasses within each class are configurable (by the service provider or network operator) through registers, accessible from the local bus of the BCM (120 in FIG. 1). Using the assigned weights for classes and subclasses of queues, the queues are serviced in a weighted round-robin manner.

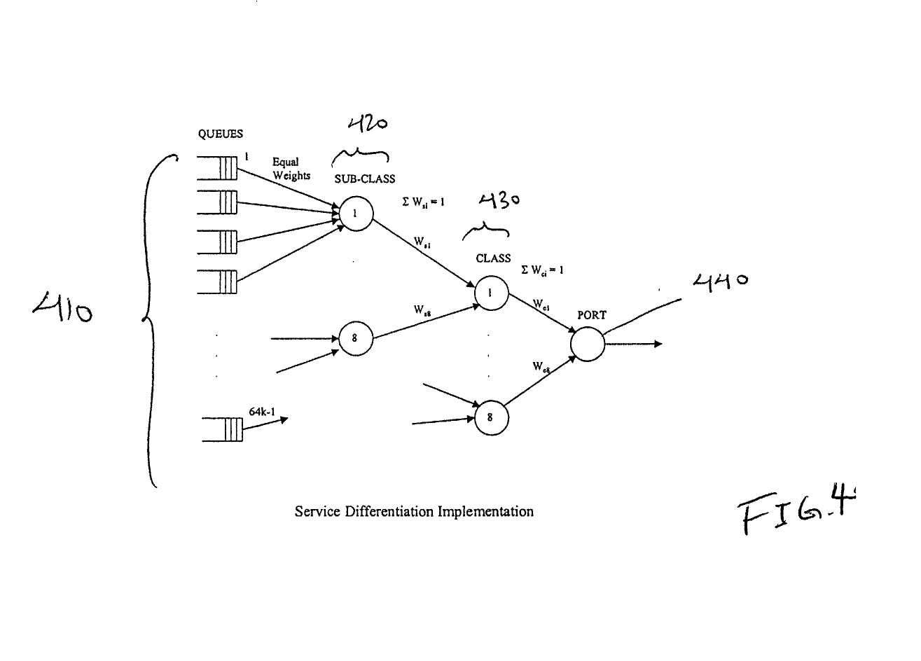

In general, the number of queues L that can be managed by the queuing processor is determined by how many bits are allocated to the Flow ID field 337. FIG. 4 depicts an exemplary implementation of just such a scheme, where 65,536 queues 410 are managed in eight classes 430, each of the classes itself having eight subclasses 420. It is understood that these numbers are embodiment specific, and depending upon design considerations, can be any integers. Any number of queues can be assigned to any class or subclass, and thus there is great flexibility. There is no required minimum number of classes or subclasses; there is merely the existence of an organizational structure. Thus, the data flows can be dictated by the conditions prevailing in the network, and dynamically classed as needed.

Given the numbers N and M, representing the numbers of possible queue classes and subclasses, respectively, a categorical set is created which can accommodate N×M, or T total classes for service differentiation. It is this number T into which the total service classes offered by the network must be mapped. In order to assign incoming packets to their correct subclass and class, the forwarding engine analyzes packets by looking at various bits in the incoming packet. These bits can comprise the IP, MLSP, or other protocol headers of any type, as are now known or may be known in the art, various application headers, source and destination addresses, as well as fields of bits in the actual data payload. The Forwarding Engine has stored in its internal registers the fields to analyze for each packet tied to some identifier field, such as the IP source or destination address, or both, as well as the algorithm mapping the bits used to select the class/subclass of service to the relevant class/subclass. All of this analysis is done at line rates, due to the specialized functionalities and high speed processing of the Forwarding Engine. Thus, the complex internal header structure necessary to facilitate the provision of complex differentiated services according to the method of the invention does not at all delay or impede the data rates through the node or in the network.

In FIG. 4, each of the subclasses 420 is assigned a weighting factor Wsi, and each class 430 is correspondingly assigned a weighting factor Wci, where the sum of all of the Wsi and of all the Wci equals unity. All queues 410 within a given subclass have equal weight. The differently weighted subclasses and classes are served with different priorities, allowing the service provider great flexibility to market various grades of service, or internally reclassify by data type, within a particular marketed grade of service.

As described above, the different classes are served by the queuing processor in a weighted round-robin system. In any round robin system the various queues are serviced for output serially. In a weighted round-robin system, some service unit is defined, and the queues are serviced in units proportional to their relative weights. For example, if the service unit is designated as being in terms of time, then some time interval in which a reasonable integral number of packets or frames can be serviced is defined as the unit. The various queues are serviced in units of time relative to their assigned priority weighting. Similar functionally equivalent methods of relative servicing of output cues can easily be imagined. The functions of the queuing processor as well cannot, and do not, delay or impede the flow of data through the node or the network from the line rate.

In the event of a fiber cut or other failure scenario, or unusually high traffic, along a particular network link, those premium service classes and subclasses will be restored and rerouted with no or minimal, depending on the service grade and the contracted for parameters relative to such grade, loss of data. Regular “best effort” packets will be dropped, as necessary. In the preferred embodiment described above, the detection of a failure is near immediate, due to the high speed electrical-optical integration as described in the co-pending patent applications under common assignment referenced above. Thus, the rerouting and restoration of all premium services data, to the extent within the bandwidth contracted for, is achievable even under the most extreme failure situations.

Given the large-scale capabilities for providing differentiated services that the present invention provides, what will next be described are a few examples of how such services can be used.

Suppose, for example, that a given a corporate customer of a network provider is a securities broker/dealer maintaining an online division. It offers its clients a secure data network connection that allows them to access their accounts, enter orders to buy and sell securities, write options, allocate pension plan and other portfolios between various investment options, and track their portfolios using various metrics. When its online customers initiate a trade or some other investment activity, it offers them real time confirmation of the execution of their trade or investment activity. The company may also provide real time securities and capital markets quotes to top tier clients. Such a company needs to assure its clients that the data flows running between them will be unbreakable, and moreover, unbreakable at state of the art real time data speeds. At the same time, the same corporate customer has a general server, which provides general information to prospective customers, may also provide delayed market quotes, research, etc., all of which are not as time sensitive as its real time trading and investment data.

Such a corporate customer of a network provider is a typical customer of premium IP services, delivered as per the method of the present invention. The priority data flows need to be unbreakable, even in the event of the most extreme high traffic and failure scenarios. No data loss can be tolerated in the top priority data flows involving actual trading/investment activity. Some data loss may be tolerable in the real time market quotations data, depending upon the importance of the client to the securities dealer corporate customer. The various levels of services flowing to and from such a customer's servers, although physically originating/terminating at the same location, need to be separately identifiable so as to be served in the network at the different priorities, according to the contracted for class of service. In the event of a fiber cut or failure, all premium data running over the affected link must be rerouted to preserve the contracted for maximum data loss, delay through the network and jitter.

Another example concerns a data network customer that broadcasts data to multiple sites, such as in pay per view entertainment content, online educational or college courses, remote video teleconferencing, intracompany video monitoring/surveillance of operations by remote management personnel, showroom video retailing, or the like. Such customers contract for premium network service that insures that all remote locations receive the same data at the same time. In the event of a fiber cut or failure, any such premium data running over the various links carrying the premium data must be rerouted to preserve the contracted for maximum data loss, delay through the network and jitter.

In each of these two examples, the customer will request that its data be segregated into various differentiated service classes. Each class will have certain requirements as to bandwidth, delay, and maximum data loss. The totality of the requested service classes of each customer in the network, T_{aggregate}, needs to be fit into the available T possible classes and subclasses. If T is less than T_{aggregate} either T needs to be increased by adding bits to the internal headers attached to incoming data by the forwarding engine, or substantially similar classes serviced identically under the same subclass. If T_{aggregate} is less than T, some classes and subclasses may be grouped together, receiving identical output service, or internal gradations may be assigned to different classes for network purposes.

While the above describes the preferred embodiment of the invention, various modifications or additions will be apparent to those of skill in the art. Such modifications and additions are intended to be covered by the following claims.

What is claimed:

1. A packet engine for use in a node in a data network, comprising:
a packet switch;
a forwarding engine; and
a queuing processor;
where the queuing processor assigns individual packets to a flow queue by parsing a header appended by the forwarding engine.

2. The packet engine of claim 1, where flow queues are assigned to a plurality of subclasses, and each subclass is assigned to a plurality of classes.

3. The packet engine of claim 2, where the queuing processor services the queues in each class with a different priority weight, where the sum of the priority weights over all of the classes equals 1.

4. The packet engine of claim 2, where the queuing processor services the queues in each subclass with a different priority weight, where the sum of the priority weights over all of the subclasses equals 1.

5. The packet engine of claim 3 where the queuing processor services the queues in each subclass with a different priority weight, where the sum of the priority weights over all of the subclasses equals 1.

6. The packet engine of any of claims 2-5, where the queues are serviced in a weighted round robin manner.

7. The packet engine of claim 6, where the round robin manner defines unit quantities of data or unit quantities of time, and allocates more units to the higher priority weights according to a user defined algorithm.

8. A packet engine for use in a node in a data network, comprising:
a packet switch;
a forwarding engine; and
a queuing processor,
where the queuing processor assigns individual packets to a flow queue by parsing a header appended by the forwarding engine, and where said header is determined by reading user defined sets of bits in each packet.

9. The packet engine of claim 8, where flow queues are assigned to a plurality of subclasses, and each subclass is assigned to a plurality of classes.

10. The packet engine of claim 9, where the queuing processor services the queues in each class with a different priority weight, where the sum of the priority weights over all of the classes equals 1.

11. The packet engine of claim 9, where the queuing processor services the queues in each subclass with a different priority weight, where the sum of the priority weights over all of the subclasses equals 1.

12. The packet engine of claim 11 where the queuing processor services the queues in each subclass with a different priority weight, where the sum of the priority weights over all of the subclasses equals 1.

13. The packet engine of any of claims 9-12, where the queues are serviced in a weighted round robin manner.

14. The packet engine of claim 13, where the round robin manner defines unit quantities of data or unit quantities of time, and allocates more units to the higher priority weights according to a user defined algorithm.

15. A method of providing differentiated services in a data network comprising:
near immediate rerouting; and
organizing packet flow queues in multiple classes,
where each class has one or more subclasses.

16. The method of claim 15, where each class is assigned a different priority weight for service.

17. The method of claim 16, where within each class, each subclass is assigned a different priority weight for service.

18. The method of any of claims 16 or 17, where the queues are serviced in a weighted round robin manner, according to the assigned priority weights.

19. The method of claim 18, where a given queue can be dynamically assigned to a given class and subclass based upon user defined criteria.

20. The method of claim 18, where the round robin manner defines unit quantities of data or unit quantities of time, and allocates more units to the higher priority weights according to a user defined algorithm.

21. The method of claim 19, where said user defined criteria include the aggregate of the various customer defined differentiated service classes served by the data network.

22. The method of claim 15 where said class and subclass are determined by reading user defined sets of bits in each packet.

23. A packet engine for use in a node in a data network, comprising:
packet switching means;
packet routing means; and
packet queuing means;
where the packet queuing means assigns individual packets to a flow queue by parsing a header appended by the packet routing means.

24. A data network comprised of multiple nodes, each comprising the packet engine of any of claims 1, 8 or 23, or implementing the method of claim 15.

25. The packet engine of any of claims 2-5, or 9-12, where the functions of the packet switching means, routing means and queuing means do not impede the flow of packets through the node at the line rate.

26. The packet engine of claim 23, where the functions of the packet switch, forwarding engine and queuing processor do not impede the flow of packets through the node at the line rate.

27. The method of claim 15, where the provision of said differentiated services does not impede the flow of data through the network at line rates.
